(19) United States
(12) Patent Application Publication
(10) Pub. No.: US 2009/0032172 A1
(43) Pub. Date: Feb. 5, 2009

(54) Method of Fabricating Pneumatic Tire

(75) Inventor: Norihiko Nakamura, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/180,611

(22) Filed: Jul. 28, 2008

(30) Foreign Application Priority Data
Aug. 1, 2007 (JP) 2007-201191

(51) Int. Cl. B60C 5/00

(52) U.S. Cl. 156/110.1

(57) ABSTRACT

A resin film having a melting point equal to or higher than 230° C. and a thickness of 20 through 150 μm is pasted to an outer surface of a side portion of an unvulcanized tire and by vulcanizing and molding the unvulcanized tire in a state of pasting the resin film, a pneumatic tire provided with the resin film at the outer surface of the tire side portion to be able to be exfoliated therefrom is fabricated.

### CROSS-REFERENCE TO RELATED APPLICATIONS

This application is based upon and claims the benefit of priority from the prior Japanese Patent Application No. 2007-201191, filed on Aug. 1, 2007; the entire contents of which are incorporated herein by reference.

### BACKGROUND

The present invention relates to a pneumatic tire, further in details, relates to a method of fabricating a pneumatic tire capable of reducing a stain at a tire outer surface and a vulcanizing mold surface.

In a background art, a pneumatic tire is fabricated by vulcanizing and molding an unvulcanized tire at inside of a mold. In such vulcanizing and molding, an additive agent of an oil, a wax or the like added to a rubber composition constituting a tire main body is bloomed to a rubber surface by a vulcanizing temperature. A bloomed substance brings about a stain in a mold by being adhered and deposited to a mold surface. When a tire is vulcanized and molded by a mold stained in this way, the stain of the mold is transcribed onto a tire outer surface and also an outlook quality of the tire is deteriorated.

Therefore, in fabricating a pneumatic tire, a stain of a mold surface is checked and when contaminated by a predetermined degree or more, the mold is cleaned. In a pneumatic tire, it is important in view of a practical outlook to ensure an outlook quality of particularly at a side portion, and therefore, it is determined whether the tire is cleaned by constituting a reference by a stain at a mold surface for molding the side portion. The mold of the tire is constituted by a number of blocks, generally, the structure is complicated, and therefore, a number of steps are required for a cleaning operation. Therefore, it is important in view of an outlook quality of a tire and also in view of fabrication cost to restrain a stain on a mold surface for molding a side portion.

Further, JP-A-07-096719 (KOKAI) (reference 1) proposes a pneumatic tire providing a nylon film layer on an outer side of a side wall rubber layer in order to promote an outlook of a tire as well as a weather resistance thereof. Further, JP-A-03-292205 (KOKAI) (reference 2) proposes a pneumatic tire laminating a thin film comprising polyethylene of an ultra high molecular weight to a side wall surface in order to promote an outlook while providing an ozone crack resistance.

According to technologies disclosed in the references, the resin film is provided to the outer surface of the tire side portion. However, the film is to be completely adhered to the tire main body, that is, the film constitutes a portion of the tire outer surface in using the tire, thereby, the weather resistance or the ozone crack resistance is promoted. Therefore, for example, in reference 1, in order to firmly adhere the nylon film layer to the side wall rubber layer, the nylon film is subjected to a pretreatment of adherence of RFL (resorcinol formaldehyde latex) treatment or the like. Therefore, the technologies do not intend to provide the resin film at a tire outer surface to be able to be exfoliated therefrom. Further, the nylon film or the polyethylene film disclosed in the references is provided with a low melting point and is inferior in the heat resistance in vulcanizing a tire and there is a concern of shrinking the film. Therefore, when the tire is assumedly subjected to use by exfoliating the film, a glossiness of the tire surface from which the film is exfoliated is deteriorated to pose a problem of being poor in an outlook.

### SUMMARY

The Invention has been carried out in view of the above-described point and it is an object thereof to provide a pneumatic tire excellent in an outlook quality by reducing a contamination of a mold surface in vulcanizing and molding a tire.

According to the invention, there is provided a pneumatic tire, including a resin film having a melting point equal to or higher than 230° C. and a thickness of 20 through 150 μm is provided at an outer surface of a tire side portion to be able to be exfoliated therefrom by pasting the resin film to an outer surface of an unvulcanized tire and vulcanizing and molding the unvulcanized tire.

According thereto, the tire is vulcanized and molded in the state of pasting the resin film, and therefore, a substance bloomed from a rubber composition constituting a tire main body to the tire outer surface by a vulcanizing temperature can be trapped by the resin film. Therefore, contamination of the mold surface can be reduced. Further, the resin film can be exfoliated from the tire main body after vulcanizing the tire and before being used as the tire even when retarded and the bloomed substance is trapped in the resin film. Therefore, the tire outer surface after exfoliating the resin film is beautiful and the outlook quality of the tire can be promoted. When the resin film is exfoliated at a stage of delivering a commercial product to an end user, also a defect or a stain in transporting the tire can be prevented from being adhered.

### BRIEF DESCRIPTION OF THE DRAWINGS

FIG. 1 is a half sectional view of a pneumatic tire according to an embodiment of the invention.

### DETAILED DESCRIPTION

Articles related to an embodiment of the invention will be explained as follows.

A resin film used in the invention is a film made of a thermoplastic resin having a melting point equal to or higher than 230° C. and having a thickness equal to 20 through 150 μm.

When the melting point of the film is lower than 230° C., a heat resistance in vulcanizing a tire is poor and a glossiness of the tire surface at which the film is exfoliated is deteriorated by shrinking the film. It is further preferable that the melting point of the film is equal to or higher than 250° C. An upper limit of the melting point of the film is not particularly limited, although the higher the melting point, the more preferable, normally, the upper limit is equal to or lower than 350° C. Here, the melting point is a value measured in conformity with DSC (differential scanning calorimeter) method of JIS K7121.

As a resin film having such a melting point, a polyester resin film of, for example, a polyethylene terephthalate (PET) film, a polybutylene terephthalate (PBT) film, a polyethylene naphthalate (PEN) film or the like, a fluorocarbon resin film or the like is pointed out.

The resin films are provided with SP values (solubility parameter) of about 6 through 13 substantially equivalent to that of a substance bloomed from a rubber composition and can trap the bloomed substance in the film.

The thickness of film is set to 20 through 150 μm since when less than 20 μm, the thickness is excessively thin and the bloomed substance permeates the film to stain the mold surface. Conversely, when the thickness of film is thick to exceed 150 μm, a performance of following to the rubber surface in vulcanizing and molding is poor, and an operability is deteriorated. Here, the thickness of the film is a value measured in conformity with JIS C2151.

Although the surface roughness of the resin film is not particularly limited, it is preferable to use a smooth film in which an arithmetic average surface roughness (Ra) is equal to or smaller than 0.1 μm. By using the film excellent in the smoothness in this way, a glossiness of the tire surface after exfoliating the film can remarkably be promoted and an excellent outlook shining in a black color can be provided. Here, the arithmetic average surface roughness (Ra) is an arithmetic average roughness to a degree of recesses and projections of a surface per unit length measured in conformity with a standard of JIS B0601 (stylus type surface roughness measuring instrument) by using a stylus type surface roughness meter.

The resin film is provided at the outer surface of the tire side portion to be able to be exfoliated therefrom by pasting the resin film to an outer surface of an unvulcanized tire and vulcanizing and molding the unvulcanized tire under the state. In details, the resin film cut in a predetermined shape is pasted to a predetermined position of an outer surface of a side portion (that is, side wall portion) of a tire before being vulcanized (that is, green tire). Further, the unvulcanized tire is vulcanized and molded at inside of a tire vulcanizing mold in a state of pasting the resin film. Thereby, a pneumatic tire providing the resin film at the outer surface of the side portion to be able to be exfoliated therefrom is fabricated.

In pasting the resin film to the unvulcanized tire, the resin film may be pasted to the unvulcanized tire before setting the unvulcanized tire to the vulcanizing mold, or/and, the resin film may be set to a predetermined position of the vulcanizing mold and the film is pasted to the unvulcanized tire by closing the mold at inside of the vulcanizing mold. Preferably, the resin film is pasted to the unvulcanized tire before being set to the vulcanizing mold as in the former. At that occasion, the film can maintain an excellent adherence with the surface of the unvulcanized tire having a viscosity and a positional shift of the resin film in being vulcanized can be prevented.

Vulcanizing and molding per se of the unvulcanized tire can be carried out in accordance with a normal method and a structure of the vulcanizing mold is not particularly limited. Although a vulcanizing temperature is not particularly limited, normally, vulcanizing is carried out at 160 through 200° C. By vulcanizing at such a high temperature, an additive of an oil, a wax or the like is bloomed from the rubber composition constituting the side portion of the tire main body to the rubber surface, however, the bloomed substance is trapped by the resin film pasted to the outer surface of the side portion and a stain of the mold surface can be reduced.

According to the pneumatic tire provided in this way, the resin film is provided at the outer surface of the side portion to be able to be exfoliated therefrom. That is, the resin film is pasted thereto without interposing an adhering agent or the like between the resin film and the tire surface to be able to be exfoliated from the tire main body after vulcanizing and molding.

After vulcanizing the tire, the resin film is exfoliated from the tire main body before being used as a tire even when retarded, the bloomed substance is trapped in the resin film, and therefore, the outer surface of the tire side portion after having been exfoliated can be made to be clean. A smooth surface of the pasted resin film is transcribed by a surface roughness (Ra) substantially the same as that of the outer surface of the tire by vulcanizing and molding, and when the resin film having Ra equal to or smaller than 0.1 μm is used, the tire surface after exfoliating the resin film is provided with an extremely smooth arithmetic average surface roughness (Ra) of 0.1 μm or smaller. Therefore, a high glossiness can be achieved by promoting a reflectance of light at the tire side portion and an excellent outlook shining in a black color can be provided.

A timing of exfoliating the resin film subjected to use of the tire by being exfoliated in this way is not particularly limited. That is, for example, the resin film may be exfoliated immediately after molding a tire, or may be exfoliated at a stage of providing the tire to an end user. Preferably, the resin film is exfoliated at a stage of providing to an end user, thereby, an adherence of a defect or a stain in storage or in transporting the tire can be prevented.

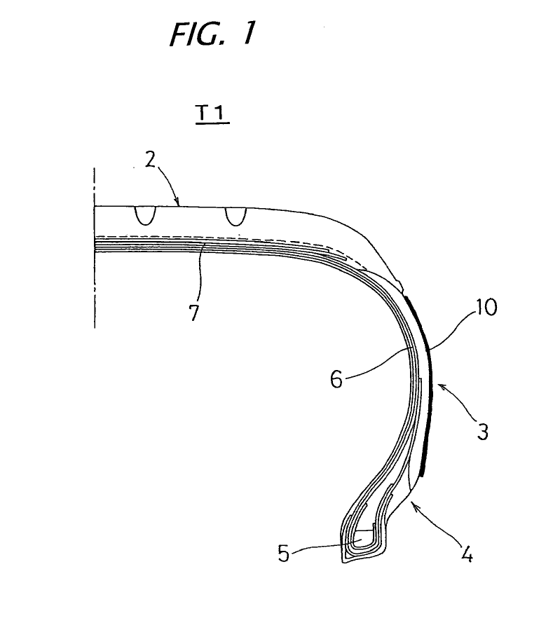

FIG. 1 is a half sectional view of a pneumatic tire T1 according to the embodiment of the invention. The tire T1 is constituted by a tread portion 2, a pair of left and right side portions 3 extended to an inner side in a tire radius direction from both ends of the tread portion 2, and a pair of left and right bead portions 4 continuous to inner ends of the side portions 3 and fixedly attached to a rim flange. According to the example, there is shown a radial tire for a passenger vehicle having a radial structure carcass 6 a carcass ply end of which is folded back to be locked around a bead core 5, and a belt layer 7 arranged at an outer periphery of the tread portion 2 of the carcass 6.

An outer surface of the side portion 3 of the tire T1 is provided with the resin film 10 to be able to be exfoliated therefrom. In this example, the resin film 10 is provided in a ring-like shape over an entire periphery in a tire peripheral direction substantially at a total in a height direction of the side portion 3.

Further, the outer surface of the side portion 3 of the tire T1 is generally provided with a mark (not illustrated) constituted by character, numeral, sign indicating maker name, brand name, tire size or the like, or diagram of a tire rotating direction or the like. The resin film 10 may be provided at a total of the side portion 3 excluding the mark portion, and/or, the resin film may be pasted to a total of the side portion 3 including the mark portion. In the case of the latter, by changing the surface roughness of the resin film pasted to the mark portion, a mark which can be recognized optically can be floated up by the glossiness.

By providing the resin film 10 over a wide range of a total of the side portion 3 in this way, a stain of a mold surface can be reduced over the total of the side portion 3, and an effect of promoting outlook of the rubber surface after exfoliation is also excellent.

### EXAMPLES

Although examples of the invention will be shown as follows, the invention is not limited to the examples.

As a rubber composition for a side wall, there was prepared a rubber composition by kneading by a normal method by using a Banbury mixer of a capacity of 200 L by a blending prescription comprising natural rubber (RSS#3) 50 weight parts, butadiene rubber (made by UBE INDUSTRIES, LTD. ‘UBEPOL-BR150B’) 50 weight parts, carbon black FEF (made by Tokai Carbon Co., Ltd. ‘SEAST SO’) 60 weight parts, aroma oil (made by JAPAN ENERGY CORPORATION ‘X-140’) 10 weight parts, paraffin wax (made by NIPPON SEIRO CO., LTD. ‘Ozoace-0355’) 2 weight parts, antiaging agent 6C (made by OUCHI SHINKO CHEMICAL INDUSTRIAL CO., LTD. ‘NOCRAC 6C’) 2 weight parts, stearic acid (made by KAO CORPORATION ‘LUNAC S-20’) 2 weight parts, zinc oxide (made by MITSUI MINNING & SMELTING CO., LTD. ‘zinc white No.1’) 3 weight parts, sulfur (made by Hosoi Chemical Industry Co., Ltd. ‘5% oil treat powder sulfur’) 2 weight parts, vulcanization promoter NS (made by OUCHI SHINKO CHEMICAL INDUSTRIAL CO., LTD. ‘NOCCELER NS-P’) 1.5 weight parts.

A pneumatic radial tire (size: 215/60R16) applying the provided rubber composition to a side portion was trially fabricated. At that occasion, in Examples 1 through 6 and Comparative Examples 2 through 4, a thermoplastic resin film described in Table 1 shown below was cut to a predetermined size, the film was pasted to an outer surface of a side portion of an unvulcanized tire as shown by FIG. 1, and set to a tire mold made of steel in a pasted state, and respective trial tires were vulcanized and molded under a vulcanizing condition of 170° C.×20 minutes.

Surface roughnesses of the respective films were measured by a method shown below. Further, with regard to the provided respective trial tires, an operability was evaluated, a glossiness of a rubber surface after exfoliating the resin film was measured, and a contamination performance of the mold was evaluated. Respective measuring or evaluating methods are as follows.

### [Surface Roughness]

An arithmetic average surface roughness (Ra) of a surface of the resin film is evaluated by using a stylus type surface roughness meter ‘E-35A’ made by TOKYO SEIMITSU CO., LTD. in conformity with a method of JIS B0601.

### [Operability]

Occurrence of wrinkle in pasting the resin film, a finish result of a tire after having been vulcanized (particularly, portion of pasting resin film), breakage in exfoliating the resin film, an easiness of exfoliation and the like are evaluated, and a case without problem is evaluated as ‘◯’, and a case with problem is evaluated as ‘×’.

### [Glossiness]

60° glossiness of a rubber surface after exfoliating the resin film at the portion of pasting the resin film of the trial tire is measured in conformity with a method of JIS Z8741 by using a gloss meter ‘VG2000’ made by Nippon Denshoku Industries Co., Ltd. Measurement is carried out at 5 portions in a tire peripheral direction and an average value thereof is calculated. The larger the value the better the glossiness.

### [Contamination Performance of Mold]

A tire is trially fabricated while confirming contamination of a mold at a side portion by optical observation and a number of times of trial fabrication until reaching a predetermined contamination to be cleaned is investigated. The contamination performance is indicated by an index constituting 100 by a value of Comparative Example 1, the larger the index, the more difficult to contaminate the mold is shown.

TABLE 1

| | resin film | | | | | | | |
|---|---|---|---|---|---|---|---|---|
| | | | melting | | surface | | | |
| | | commercial | point | thickness | roughness | | | contamination |
| | kind | name.maker | (° C.) | (μm) | Ra (μm) | operability | glossiness | of mold |
| Example 1 | PET | Toray-made | 260 | 25 | 0.03 | ∘ | 60 | 115 |
| | | Lumirror S10 | | | | | | |
| Example 2 | PET | Toray-made | 260 | 50 | 0.03 | ∘ | 62 | 120 |
| | | Lumirror S10 | | | | | | |
| Example 3 | PET | Toray-made | 260 | 125 | 0.03 | ∘ | 62 | 130 |
| | | Lumirror S10 | | | | | | |
| Example 4 | Fluorocarbon | Toray-made | 310 | 25 | 0.04 | ∘ | 64 | 120 |
| | resin | Toyoflon PFA | | | | | | |
| Example 5 | Fluorocarbon | Toray-made | 310 | 50 | 0.04 | ∘ | 65 | 125 |
| | resin | Toyoflon PFA | | | | | | |
| Example 6 | Fluorocarbon | Toray-made | 310 | 125 | 0.04 | ∘ | 66 | 135 |
| | resin | Toyoflon PFA | | | | | | |
| Comparative | none | | | | | ∘ | 1.3 | 100 |
| Example 1 | | | | | | | | |
| Comparative | nylon 6 | Toyo Boseki | 220 | 25 | 0.03 | x | 20 | 110 |
| Example 2 | | Harden N1100 | | | | | | |
| Comparative | PET | Toray-made | 260 | 188 | 0.03 | x | 64 | 140 |
| Example 3 | | Lumirror S10 | | | | | | |
| Comparative | PET | Toray-made | 260 | 10 | 0.03 | x | 60 | 110 |
| Example 4 | | Lumirror S10 | | | | | | |

The result is as shown in Table 1. According to Examples 1 through 6, in contrast to Comparative Example 1 of a control tire which was not pasted with a resin film, a rubber surface having a very small surface roughness can be formed without deteriorating the operability, and therefore, a side portion of an excellent outlook achieving a high glossiness and shining in black color can be formed, further, also contamination of the mold was reduced.

In contrast thereto, according to Comparative Example 2 using a nylon film, the melting point was low, and therefore, wrinkle was brought about in vulcanizing a tire and the glossiness was inferior. Further, according to Comparative Example 3, the thickness of the resin film was excessively large, and therefore, a performance of following to the rubber surface was deteriorated, a problem was posed in the finish result after vulcanization, and the operability was inferior. Further, according to Comparative Example 4, the thickness of the resin film was excessively small, the bloomed substance permeates the film, and an effect of reducing contamination of the mold was insufficient.

What is claimed is:

1. A method of fabricating a pneumatic tire, comprising pasting a resin film having a melting point equal to or higher than 230° C. and a thickness of 20 through 150 μm to an outer surface of a side portion of an unvulcanized tire, and vulcanizing and molding the unvulcanized tire in the state of pasting the resin film, whereby the resin film is provided at the outer surface of the tire side portion to be able to be exfoliated therefrom.

2. The method of fabricating a pneumatic tire according to claim 1, wherein an arithmetic average surface roughness (Ra) of the resin film is equal to or smaller than 0.1 μm.

3. The method of fabricating a pneumatic tire according to claim 1, wherein the resin film is a polyester resin film or a fluorocarbon resin film.

4. The method of fabricating a pneumatic tire according to claim 1, wherein the resin film is provided in a ring-like shape over an entire periphery in a tire peripheral direction at substantially a total in a height direction of the tire side portion.

5. The method of fabricating a pneumatic tire according to claim 1, wherein the resin film is provided at a total of the tire side portion excluding a mark portion.
